(19) United States
(12) Patent Application Publication
(10) Pub. No.: US 2025/0298775 A1
(43) Pub. Date: Sep. 25, 2025

(54) PROCESSING QUERIES WITH PREDICATES IN DATABASE SYSTEMS

(71) Applicant: Snowflake Inc., Bozeman, MT (US)

(72) Inventors: Omer Arap, San Jose, CA (US); Damien Dam, Berlin (DE); Ismail Oukid, Berlin (DE); Juliane K. Waack, Berlin (DE); Andreas Zimmerer, Berlin (DE)

(21) Appl. No.: 18/614,012

(22) Filed: Mar. 22, 2024

(51) Int. Cl. G06F 16/14

(52) U.S. Cl. CPC G06F 16/148

(57) ABSTRACT

Systems and methods are provided for processing a query with one or more predicates in a database system. The system and methods receive a query comprising one or more predicates. The systems and methods process metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query. The system and methods perform, based on the query, one or more database operations on the set of fully matched files prior to processing the set of partially-matched files.

### TECHNICAL FIELD

Examples of the disclosure relate generally to data platforms and databases and, more specifically, to efficiently processing queries with predicates on the databases.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed. Various operations performed on a database, such as joins and unions, involve combining query results obtained from different data sources (e.g., different tables, possibly on different databases) into a single query result. The accuracy and efficiency at which various operations can be performed are impacted by the schema associated with various rows/columns of the tables.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based data platform, in accordance with some examples.

FIG. 2 is a block diagram illustrating components of a compute service manager, in accordance with some examples.

FIG. 3 is a block diagram illustrating components of an execution platform, in accordance with some examples.

FIG. 4 is a block diagram of a query processing system, in accordance with some examples.

FIGS. 5 and 6 are illustrative inputs and outputs of the query processing system, in accordance with some examples.

FIG. 7 is a flow diagram illustrating operations of the query processing system, in accordance with some examples.

FIG. 8 illustrates a diagrammatic representation of a machine in the form of a computer system within which a set of instructions may be executed for causing the machine to perform any one or more of the methodologies discussed herein, in accordance with some examples.

### DETAILED DESCRIPTION

Reference will now be made in detail to specific examples for carrying out the inventive subject matter. These examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. The data platform may include one or more databases that are respectively maintained in association with any number of customer accounts (e.g., entities), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well. The entities that are allocated services on the data platform may be third parties relative to an entity that provides or hosts the data platform.

Users and/or executing processes that are associated with a given customer account may, via one or more types of clients, be able to cause data to be ingested into the database, and may also be able to manipulate the data, add additional data, remove data, run queries against the data, generate views of the data, and so forth. In an example implementation of a data platform, a given database is represented as an account-level object within a customer account, and the customer account may also include one or more other account-level objects such as users, roles, and/or the like. Furthermore, a given account-level database object may contain one or more objects such as tables, schemas, views, streams, tasks, and/or the like.

Conventional systems allow caller processes or tasks to run queries against data stored in the databases. These queries can sometimes include predicates (or conditions) that need to be met in order for the underlying query operations to be applied. A predicate is an expression that evaluates to TRUE, FALSE, or UNKNOWN. Predicates are used in the search condition of WHERE clauses and HAVING clauses, the join conditions of FROM clauses, and other constructs where a Boolean value is required. For example, a query can include a select operation with a specific date as a predicate. This query can cause the database operation to only select rows that include the specific date.

Conventional systems blindly scan every file in the database, (and/or metadata for every file in the database) to find those files that match the one or more predicates of the query. After the files are found, the conventional systems apply the database operations specified in the query. The need to scan every file in the database to selectively apply database operations of a query is incredibly time-consuming and wastes system resources. The time it can take to fully execute and complete such queries can be daunting and can prevent resources from being used for other tasks which reduces the overall efficiencies of the database systems.

When certain information is to be extracted from a database, a query statement may be executed against the database data. A data platform may process the query and return certain data according to one or more query predicates that indicate what information should be returned by the query. The data platform extracts specific data from the database and formats that data into a readable form. However, it can be challenging to execute queries on a very large table because a significant amount of time and computing resources are required to scan an entire table to identify data that satisfies the query.

As noted above, it can be challenging to execute queries on a very large table because a significant amount of time and computing resources are required to scan an entire table to identify data that satisfies the query. To avoid scanning an entire table, a process known as “pruning” is often performed as part of processing queries. Pruning involves using metadata to determine which portions of a table are not pertinent to a query, avoiding those non-pertinent portions when responding to the query, and scanning only the pertinent portions to respond to the query. Metadata may be automatically gathered about all rows stored in a given portion of the table, including: a maximum and minimum value for each of the columns in the portion; a number of distinct values; and/or additional properties used for both optimization and efficient query processing.

A given table may be organized as records (e.g., rows or a collection of rows) that each include one or more attributes (e.g., columns). A data platform may physically store database data (e.g., a table) in multiple storage units, which may be referred to as partitions, micro-partitions, and/or by one or more other names. In an example, multiple storage units of a database can be stored in a block and multiple blocks can be grouped into a single file. That is, a database can be organized into a set of files where each file includes a set of blocks where each block includes a set of more granular storage units such as partitions. Consistent with this example, for a given column, all blocks are stored contiguously and blocks for different columns are row aligned. Data stored in each block can be compressed to reduce its size. A block storing compressed data may also be referred to as a “compression block” herein. Accordingly, pruning may include determining which files, blocks, partitions, micro-partitions or other storage units of a table are not pertinent to a query. It should be understood that the terms “row” and “column” are used for illustration purposes and these terms are interchangeable. Data arranged in a column of a table can similarly be arranged in a row of the table.

Aspects of the present disclosure include systems, methods, and devices to address, among other problems, the aforementioned shortcomings of conventional data platforms by improving the way in which queries with predicates are processed. Specifically, disclosed techniques preprocess predicates of a query against metadata of files stored in the database to group files into fully-matched files and partially-matched files. Once the files are grouped in this manner, the disclosed techniques can perform the database operations of the query on the fully-matched files before the partially-matched files and/or treat the fully-matched files differently during query processing. This avoids the need to scan all of the files in the database systems given the knowledge obtained initially from the metadata. Namely, by using the metadata about files stored in the database, the amount of files that need to be scanned to determine whether they satisfy the predicates of the query is reduced. This substantially improves the way in which the queries with predicates are handled in the database system and reduces the amount of resources dedicated to processing queries.

In some examples, the disclosed techniques receive a query comprising one or more predicates. The disclosed techniques process metadata associated with a database comprising a plurality of files to identify a set of fully-matched files and a set of partially-matched files, with the set of fully-matched files including a first group of files in which all rows of each file match each of the one or more predicates of the query, and the set of partially-matched files including a second group of files having rows that possibly match the one or more predicates of the query. The disclosed techniques perform, based on the query, one or more database operations on the set of fully matched files prior to processing the set of partially-matched files. By performing these operations, the data platform increases utilization of execution node processing capability and avoids waste of resources and inefficient use of resources.

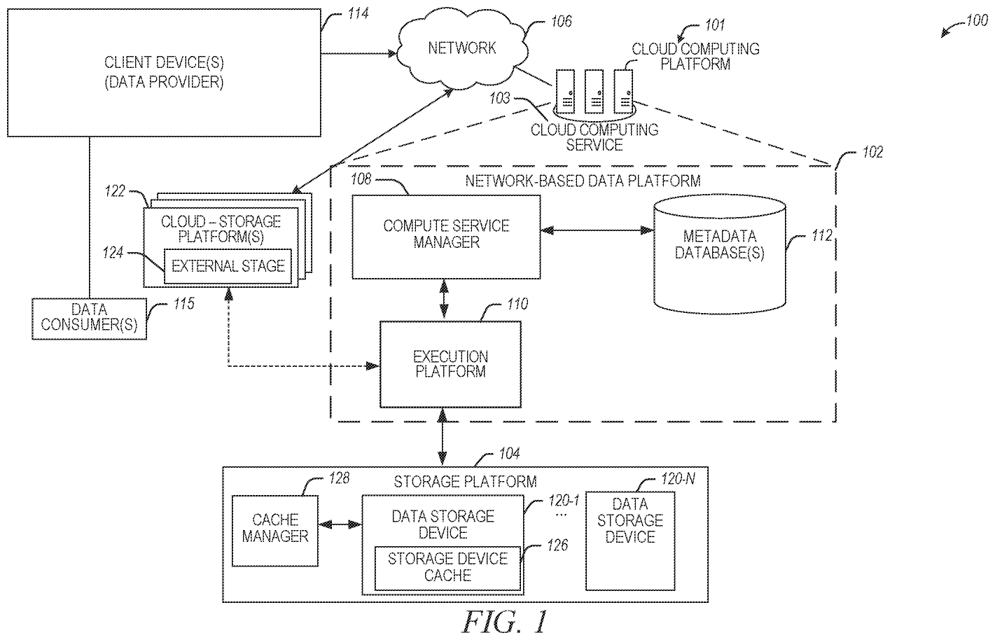

FIG. 1 illustrates an example computing environment 100 that includes a data platform in the example form of a network-based data platform 102, in accordance with some examples. To avoid obscuring the example subject matter with unnecessary detail, various functional components that are not germane to conveying an understanding of the example subject matter have been omitted from FIG. 1. However, a skilled artisan will readily recognize that various additional functional components may be included as part of the computing environment 100 to facilitate additional functionality that is not specifically described herein. In other examples, the computing environment may comprise another type of network-based database system or a cloud data platform. For example, in some aspects, the computing environment 100 may include a cloud computing platform 101 with the network-based data platform 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., structured query language (SQL) queries with or without predicates, analysis), as well as other processing capabilities (e.g., parallel execution of sub-plans as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (e.g., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform. The techniques described in this disclosure pertain to non-volatile storage devices that are used for the internal storage location and/or the external storage location.

From the perspective of the network-based data platform 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—For example, in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based data platform 102 of the cloud computing platform 101 is in communication with the cloud storage platforms 104 and 122 (e.g., Amazon Web Services (AWS)®, Microsoft Azure Blob Storage®, or Google Cloud Storage). The network-based data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based data platform 102.

The network-based data platform 102 comprises a compute service manager 108, an execution platform 110, and one or more metadata databases 112. The network-based data platform 102 hosts and provides data reporting and analysis services to multiple client accounts. The compute service manager 108 coordinates and manages operations of the network-based data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user (entity) of one of the multiple client accounts (multiple entity accounts) supported by the network-based data platform 102. A user may utilize the client device 114 to submit data storage, retrieval, and analysis requests to the compute service manager 108. Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers, entities, and providers. Such actions shall be understood to be performed concerning client device (or devices) 114 operated by such users (also referred to as entities). For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some examples, a user account object lists users authorized to access at least one target account (e.g., an account of a data provider or data consumer 115). In some examples, a roles account object configures privileges for the users to access the at least one target account. In some aspects, a warehouse object indicates compute resources (e.g., at least one virtual warehouse of the execution platform 110) for executing a workload associated with one or more databases of the data provider. In some examples, a resource monitor object configures monitoring usage of the compute resources.

The compute service manager 108 is also coupled to one or more metadata databases 112 that store metadata about various functions and aspects associated with the network-based data platform 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata.

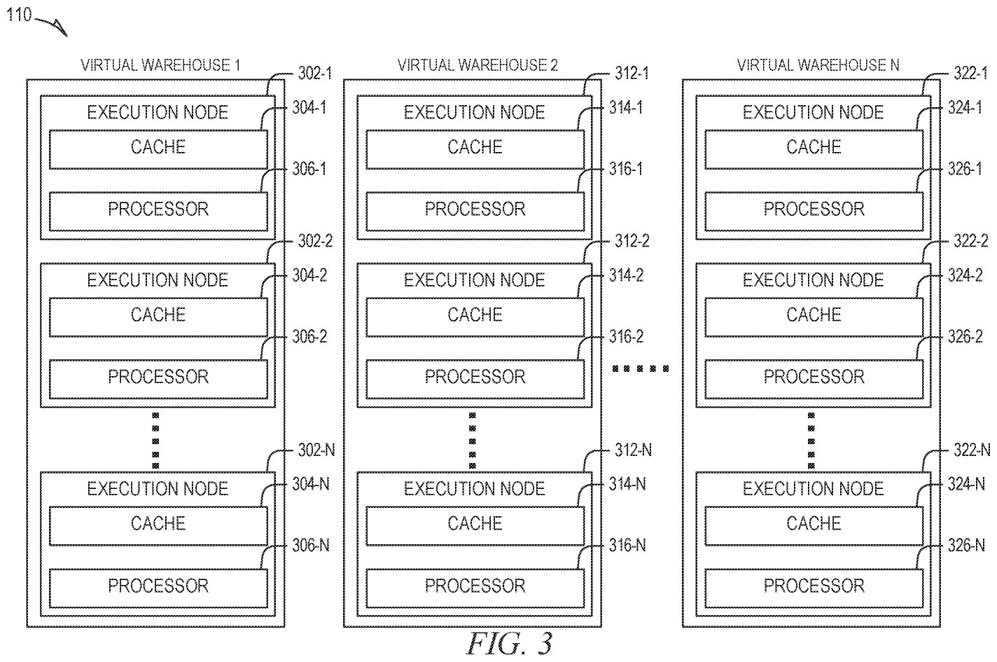

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some examples, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like.

In some examples, at least one storage device cache 126 (e.g., an internal cache) may reside on one or more of the data storage devices 120-1-120-N, and at least one external stage 124 may reside on one or more of the cloud storage platforms 122. In some examples, a single storage device cache 126 can be associated with all of the data storage devices 120-1-120-N so that the single storage device cache 126 is shared by and can store data associated with any one of the data storage devices 120-1-120-N. In some examples, each data storage device 120-1-120-N can include or implement a separate storage device cache 126. A cache manager 128 handles the transfer of data from the data storage devices 120-1-120-N to the storage device cache 126. The cache manager 128 handles the eviction of data from the storage device cache 126 to the respective associated data storage devices 120-1-120-N. The storage platform 104 can include one or more hard drives and/or can represent a plurality of hard drives distributed on a plurality of servers in a cloud computing environment.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

The compute service manager 108, metadata database(s) 112, execution platform 110, and storage platform 104 are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based data platform 102. Thus, in the described examples, the network-based data platform 102 is dynamic and supports regular changes to meet the current data processing needs.

During a typical operation, the network-based data platform 102 processes multiple jobs (e.g., operators of sub-plans) determined by the compute service manager 108. These jobs (e.g., caller processes) are scheduled and managed by the compute service manager 108 to determine when and how to execute the job. For example, the compute service manager 108 may divide the job into multiple discrete tasks (e.g., caller processes) and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task (e.g., in a storage device cache 126, such as an HDD cache or random access memory (RAM)) and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

According to various examples, the execution platform 110 executes a query according to a query plan determined by the compute service manager 108. As part of executing the query, the execution platform 110 performs a table scan in which one or more portions of a database table are scanned to identify data that matches the query. More specifically, the database table can be organized into a set of files where each file comprises a set of blocks (or records), and each block (or record) stores at least a portion of a column (or row) of the database. Each execution node provides multiple threads of execution, and in performing a table scan, multiple threads perform a parallel scan of the set of blocks (or records) of a file, which may be selected from a scan set corresponding to a subset of the set of files into which the database is organized.

In some examples, the execution platform 110 determines that a query is received that includes one or more predicates. In such cases, the execution platform 110 pre-processes metadata associated with the set of files to group the files into fully-matched files and partially-matched files and/or non-matched files. Fully-matched files represent or include a list of files that have rows that match exactly the one or more predicates. For example, if the predicate is a specific date, each row in the list of fully-matched files includes a column with the same specific date. For example, a simple example can include a query specifying select * from T where A>0, and table T contains 3 files whose metadata for column A are as follows: File 1: min A=1, max A=5; File 2: min A=−3, max A=2; and File 3: min A=−10, max A=−6. Based on this information, the execution platform 110 can safely prune away File 3 since it knows that there are no rows from it that can satisfy the query's predicate. File 1 and File 2 both contain rows that potentially can be included in the query result, thus they must be sent for scanning. The list of files that are not pruned due to potentially containing matching rows are referred to as matchedFiles (MF). At the end of compilation, a potentially smaller subset of MF that are sent for scanning is called the scanset. In addition, the execution platform 110 determines that File 1 contains rows whose values for column A range from 1 to 5 which can all be part of the query result. This list of files which have this characteristic are referred to as fullyMatchedFiles (FMF). One or more MFs which are not part of FMF are referred to partiallyMatchedFiles (PMF), in which File 2 is an example.

Specifically, partially-matched files represent or include a list of files that have rows that may or may not match the one or more predicates. For example, if the predicate is a specific date, one or more rows in some of the list of fully-matched files includes a column with the same specific date. The partially-matched files can be identified if the metadata associated with the partially-matched files includes a range where the specific date falls within the range. In such cases, there may or may not be rows with that specific date. Non-matched files represent files that have no rows that match the one or more predicates of the query.

After grouping the files in this manner, the execution platform 110 can process the fully-matched files first before scanning or processing other types of files (e.g., the partially-matched files). If processing the fully-matched files satisfies completion of the query, the execution platform 110 returns a result to a caller process or application. If processing the fully-matched files fails to satisfy completion of the query, the execution platform 110 obtains the partially-matched files and scans each row of the partially-matched files to find files that satisfy the query. Once those partially-matched files complete being scanned, the execution platform 110 forms a result that includes a result of processing the fully-matched files and the partially-matched files to the caller process or application.

The cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

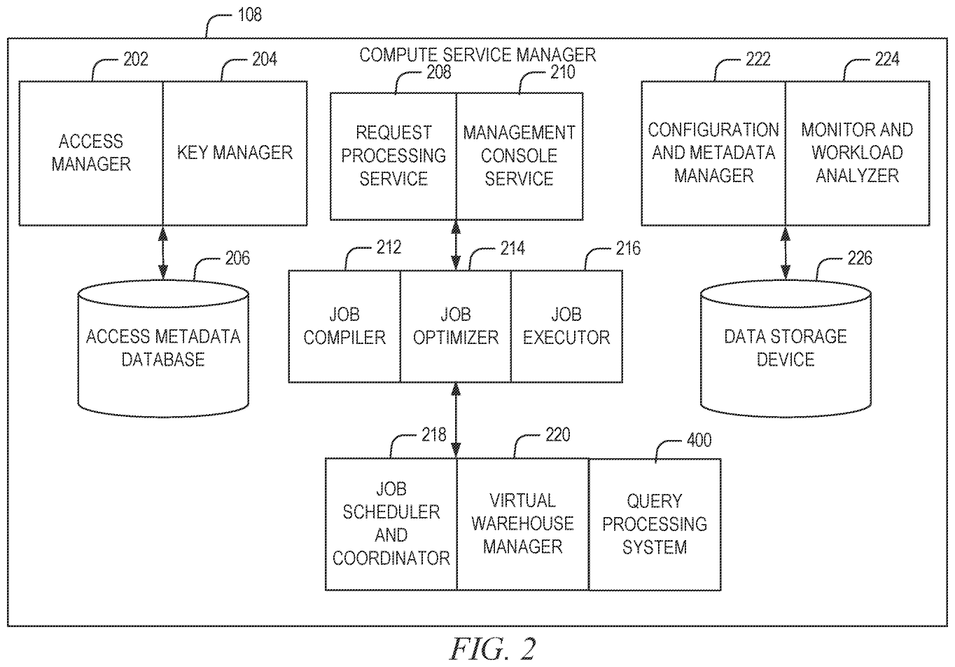

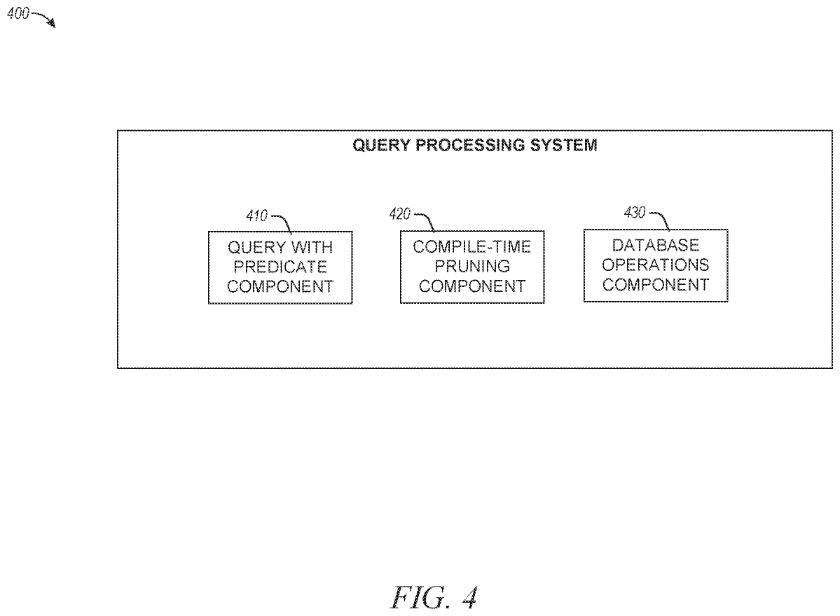

FIG. 2 is a block diagram illustrating components of the compute service manager 108, in accordance with some examples of the present disclosure. As shown in FIG. 2, the compute service manager 108 includes an access manager 202 and a credential management system (or key manager) 204 coupled to an access metadata database 206, which is an example of the metadata database(s) 112. The compute service manager 108 also includes a query processing system 400, discussed in more detail below in connection with FIG. 4.

Access manager 202 handles authentication and authorization tasks for the systems described herein. The credential management system 204 facilitates the use of remotely stored credentials to access external resources such as data resources in a remote storage device. As used herein, the remote storage devices may also be referred to as “persistent storage devices,” “non-volatile storage devices,” “cloud storage devices,” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110, in a storage device cache 126, or in a data storage device in storage platform 104.

A management console service 210 supports access to various systems and processes by administrators and other system managers. Additionally, the management console service 210 may receive a request to execute a job and monitor the workload on the system. The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an example, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries by one or more execution nodes of the execution platform 110. In some cases, coordinator 218 handles the execution of a deletion operation or task to selectively delete portions of one or more tables according to one or more deletion criteria (e.g., deletion policies).

Additionally, compute service manager 108 includes configuration and metadata manager 222, which manages the information related to the data stored in the remote data storage devices and the local buffers (e.g., the buffers in execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based data platform 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based data platform 102. For example, data storage device 226 may represent buffers in execution platform 110, storage devices in storage platform 104, or any other storage device.

FIG. 3 is a block diagram illustrating components of the execution platform 110, in accordance with some examples of the present disclosure. As shown in FIG. 3, the execution platform 110 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing data from any of the data storage devices 120-1 to 120-N and their associated storage device cache 126 (e.g., via a respective lock file) shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some examples, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some examples, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state. Each virtual warehouse can separately and independently host processes and allocate resources across multiple user accounts or multiple entities. In this way, each virtual warehouse can implement a multi-tenant data platform. In some cases, a first virtual warehouse can be associated with a first likelihood of service disruption while a second virtual warehouse can be associated with a second likelihood of service disruption. Certain user accounts to which resources of the first virtual warehouse are allocated can be notified about service disruptions if the first likelihood transgresses a specified threshold. Certain user accounts to which resources of the second virtual warehouse are allocated can be notified about service disruptions if the second likelihood transgresses the same or different specified threshold.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the cloud storage platform 104. The techniques described with respect to the cache manager 128 of the storage platform 104 (e.g., an HDD) can be similarly applied to the cache 304-N, 314-N, and 324-N of the execution nodes 302-N, 312-N, and 322-N.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location. A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 is a block diagram illustrating an example of the query processing system 400 which can be implemented by any of the virtual warehouses of the execution platform 110 (and/or by the compute service manager 108), in accordance with some examples. The query processing system 400 can include a query with predicate component 410, a compile-time pruning component 420, and a database operations component 430.

The query processing system 400 receives a query that includes one or more predicates. The query processing system 400 processes metadata associated with a database including a plurality of files to identify a set of fully-matched files and a set of partially-matched files. The set of fully-matched files includes a first group of files in which all rows of each file match each of the one or more predicates of the query. The set of partially-matched files includes a second group of files having rows that possibly match the one or more predicates of the query. The query processing system 400 performs, based on the query, one or more database operations on the set of fully matched files prior to processing the set of partially-matched files.

Specifically, the predicate component 410 can receive, from a caller application or process, a query that includes one or more predicates. For example, the query can include a SELECT operation, an AGGREGATION operation, a TOP (or LIMIT) elements operation, and/or an INTERCHANGE operation. The query can also include one or more predicates, such as a row limit value or number (setting a maximum number of results to return), a date range, a specific date, a specific value, a range of values, and/or any other type of condition or Boolean operation. The predicate component 410 can access metadata associated with the database that includes a plurality of files. The metadata can include various information about each file and its respective rows, such as the number of rows, a range of values of columns of the rows, type of values, and so forth.

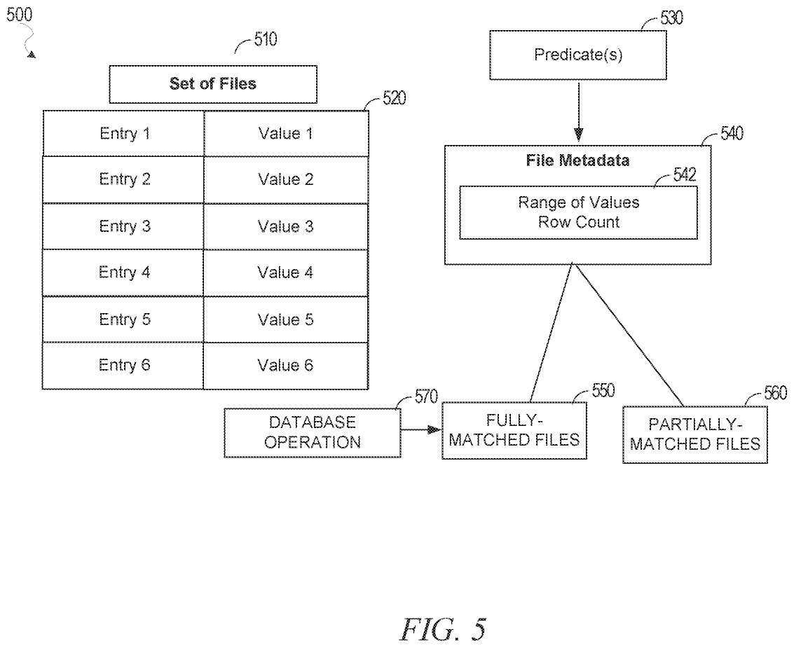

For example, as shown in the example diagram 500 of FIG. 5, the predicate component 410 can access a set of files 510 stored in the database. Each file can include one or more entries and respective values 520. Metadata 540 can store data 542 including the range of values and row count, sum, or average for each file. The predicate component 410 can apply one or more predicates 530 of the query to the metadata 540 in order to group the set of files 510 into fully-matched files 550 and partially-matched files 560. For example, if the predicate component 410 determines that the metadata 540 of a particular file indicates that the rows of the file match each of the one or more predicates 530, the predicate component 410 adds that file to the fully-matched files 550. Namely, the predicate may specify a condition that a value be greater than a threshold. In such cases, the predicate component 410 can determine that the range of values for the respective values 520 in a particular file is greater than the threshold. In such cases, the predicate component 410 selects to include that particular file in the fully-matched files 550.

As another example, if the predicate component 410 determines that the metadata 540 of an individual file indicates that the rows of the file possibly match each of the one or more predicates 530, the predicate component 410 adds that file to the partially-matched files 560. Namely, the predicate may specify a condition that a value be greater than a threshold. In such cases, the predicate component 410 can determine that the threshold of the predicate falls between the range of values for the respective values 520 in the individual file. This indicates that some rows of the individual file have values that are greater than the threshold and so satisfy the predicate while other rows have values that are less than the threshold and so fail to satisfy the predicate. In such cases, the predicate component 410 selects to include that individual file in the partially-matched files 560.

Any one of the set of files 510 that is not placed in either the fully-matched files 550 or the partially-matched files 560 is associated with non-matched files and is not processed further by the query. After completing grouping of the files based on the predicates of the query, the predicate component 410 applies one or more database operations 570 specified in the query to the fully-matched files 550 and/or the partially-matched files 560. For example, the predicate component 410 provides the fully-matched files 550 to the compile-time pruning component 420 along with the database operations indicated in the received query.

The compile-time pruning component 420 applies the database operations to the fully-matched files 550 (obtained from the query with predicate component 410. For example, the database operation can include a SELECT operation with a row limit value. In such cases, the compile-time pruning component 420 obtains a first file from the fully-matched files 550 and determines, based on the metadata associated with the first file, the number of rows of the first file. In response to determining that the number of rows of the first file satisfy the row limit value, the compile-time pruning component 420 provides a number of rows of the first file up to the row limit value to the database operations component 430 to return as a result to the caller process or application. Such a process may only be applied to fully-matched files 550 and not for any partially-matched files because it is not known if enough rows are available in the partially-matched files. In response to determining that the number of rows of the first file fails to satisfy the row limit value, the compile-time pruning component 420 determines, based on the metadata associated with the second file, the number of rows of the second file. If the total number of rows of the first file and some or all of the rows of the second file satisfy the row limit value, the compile-time pruning component 420 provides a number of rows of the first and second files up to the row limit value to the database operations component 430 to return as a result to the caller process or application.

In this way, the compile-time pruning component 420 and database operations component 430 return a result to the caller process or application in response to receiving the query with the predicates without processing or scanning the partially-matched files 560. Namely, scanning of the rows of the partially-matched files 560 can be skipped over which increases the efficiency of processing a query and the database operations component 430 only needs to scan enough fully-matched files to satisfy a query and may not need to scan all of the fully-matched files.

In some cases, the compile-time pruning component 420 determines that a total of all of the fully-matched files include fewer rows than the row limit value.

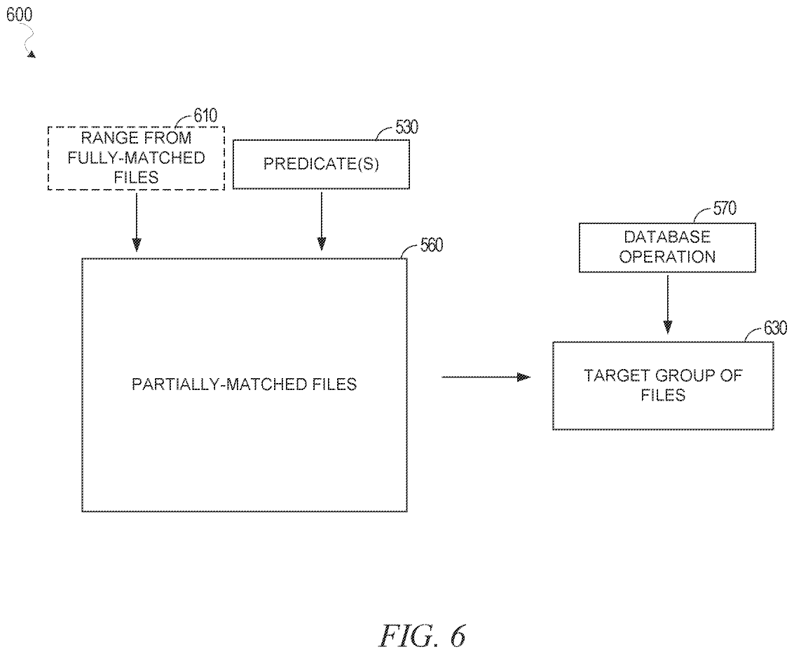

Namely, the metadata for each of the compile-time pruning component 420 indicates that the total number of rows fails to satisfy the row limit value of the query. In such cases, the compile-time pruning component 420 accesses the partially-matched files 560. The compile-time pruning component 420 provides the partially-matched files 560 to the database operations component 430 for processing and scanning according to the query and the one or more predicates. As shown in the diagram 600 of FIG. 6, the database operations component 430 receives the partially-matched files 560 and applies the one or more predicates 530 to rows of each file in the partially-matched files 560. The database operations component 430 compares the values of each row of the partially-matched files 560 to the one or more predicates 530 to determine whether the corresponding row satisfies the one or more predicates 530. In such cases, the database operations component 430 adds the file and/or the row to a target group of files 630. The one or more database operations 570 is then applied to the target group of files 630 to select rows from the target group of files 630 to return as a result of the query. Namely, some of the rows of the target group of files 630 are combined and collected with the rows of the fully-matched files 550 and returned to the caller application or process as a result of processing the query with the one or more predicates.

In some examples, the predicate component 410 determines that the query includes an aggregation operation. In such cases, the predicate component 410 provides the fully-matched files 550 to the compile-time pruning component 420 along with the aggregation operation. The compile-time pruning component 420 obtains a first aggregation value from metadata associated with the fully-matched files 550 without scanning the fully-matched files 550. The first aggregation value can represent a count, sum, or average of rows of the set of fully-matched files 550. In some cases, the first aggregation value can represent a minimum or maximum value of the rows of the target group of the set of fully-matched files 550. Namely, the compile-time pruning component 420 can generate a result of processing the query simply by accessing the metadata associated with the fully-matched files 550 without having to scan rows of the fully-matched files 550. This is because the fully-matched files 550 are already known to have rows that each match the predicates and there is no need to further scan the contents of the files. After obtaining this first aggregation value, the compile-time pruning component 420 accesses the partially-matched files 560 and scans the rows of those files to obtain a second aggregation value.

For example, the compile-time pruning component 420 provides the partially-matched files 560 to the database operations component 430 for processing and scanning according to the query and the one or more predicates. As shown in FIG. 6, the database operations component 430 receives the partially-matched files 560 and applies the one or more predicates 530 to rows of each file in the partially-matched files 560. The database operations component 430 compares the values of each row of the partially-matched files 560 to the one or more predicates 530 to determine whether the corresponding row satisfies the one or more predicates 530. In such cases, the database operations component 430 adds the file and/or the row to the target group of files 630. The one or more database operations 570 is then applied to the target group of files 630 to count, sum, or average the number of rows of the target group of files 630 to return as the second aggregation value for the query. The first and second aggregation values are summed and returned to the caller application or process as a result of processing the query with the one or more predicates.

In some examples, the predicate component 410 determines that the query includes a TOP/LIMIT elements operation (e.g., top ten elements) and/or also includes an ORDER BY clause. In such cases, the predicate component 410 provides the fully-matched files 550 to the compile-time pruning component 420 along with the TOP/LIMIT elements operation. The compile-time pruning component 420 scans the rows of the fully-matched files 550 to find those rows with the greatest values corresponding to an identified entry. The compile-time pruning component 420 can then compute a range or boundary based on the range of the values of the first number (e.g., ten) of entries. This range 610 is then provided to the database operations component 430 along with the partially-matched files 560. The database operations component 430 can then compare the range 610 with the corresponding values for the entries in the partially-matched files 560.

The database operations component 430 prune the partially-matched files 560 based on the range 610. In this way, the database operations component 430 can only select to include in the target group of files 630 any file of the partially-matched files 560 which has a value that exceeds the highest value of the range 610. The database operations component 430 can then select the rows with entries having the highest values up to a maximum specified in the query (e.g., the top ten rows) including some of the rows of the fully-matched files 550 and/or some of the rows of the partially-matched files 560. If none of the rows of the partially-matched files 560 includes a value greater than the higher end of the range 610, the database operations component 430 simply returns a quantity of rows of the fully-matched files 550 corresponding to the maximum specified in the query which were identified as having the greatest values.

In some examples, the predicate component 410 determines that the query includes an INTERCHANGE operation (e.g., insert operation, an update operation, a merge operation, and/or a clone operation). In such cases, the predicate component 410 provides the fully-matched files 550 to the compile-time pruning component 420 along with the INTERCHANGE operation. The compile-time pruning component 420 applies the interchange operation to the fully-matched files 550 without scanning the fully-matched files 550. Similarly, as discussed above, the compile-time pruning component 420 and/or the database operations component 430 can scan the partially-matched files 560 to selectively apply the interchange operation to those files that have rows that satisfy the one or more predicates. In cases where the INTERCHANGE operation includes a clone operation, the compile-time pruning component 420 adds a pointer to fully-matched files 550 in a new table without first scanning those files. The compile-time pruning component 420 identifies those files in the partially-matched files 560 that include rows that match the predicates and adds, to the new table, a new copy of files within the partially-matched files 560 having the rows that satisfy the one or more predicates. The compile-time pruning component 420 can perform similar operations for DELETE operations. For example, the compile-time pruning component 420 can just delete fully-matched files without scanning each row of the fully-matched files to verify that the predicate(s) is/are satisfied.

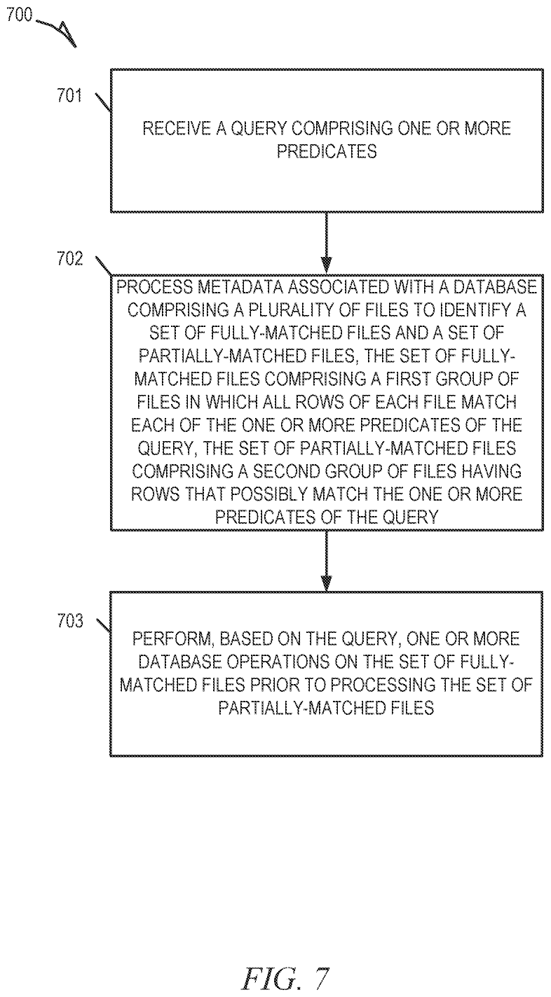

FIG. 7 is a flow diagram illustrating operations of a method 700 of the query processing system 400, in accordance with some examples. The method 700 may be embodied in computer-readable instructions for execution by one or more hardware components (e.g., one or more processors) such that the operations of the method 700 may be performed by components of data platform 102 such as the execution platform 110. Accordingly, the method 700 is described below, by way of example with reference thereto. However, it should be appreciated that method 700 may be deployed on various other hardware configurations and is not intended to be limited to deployment within the data platform 102. Depending on the example, an operation of the method 700 may be repeated in different ways or involve intervening operations not shown. Though the operations of the method 700 may be depicted and described in a certain order, the order in which the operations are performed may vary among examples, including performing certain operations in parallel or performing sets of operations in separate processes.

At operation 701, the query processing system 400 receives a query comprising one or more predicates, as discussed above.

At operation 702, the query processing system 400 processes metadata associated with a database comprising a plurality of files to identify a set of fully-matched files and a set of partially-matched files. The set of fully-matched files can include a first group of files in which all rows of each file match each of the one or more predicates of the query. The set of partially-matched files can include a second group of files having rows that possibly match the one or more predicates of the query, as discussed above.

At operation 703, the query processing system 400 performs, based on the query, one or more database operations on the set of fully-matched files prior to processing the set of partially-matched files, as discussed above.

Described implementations of the subject matter can include one or more features, alone or in combination as illustrated below by way of example.

Example 1: A system comprising: at least one hardware processor; and at least one memory storing instructions that cause the at least one hardware processor to execute operations comprising: receiving a query comprising one or more predicates; processing metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query; and performing, based on the query, one or more database operations on the set of fully-matched files prior to processing the set of partially-matched files.

Example 2. The system of Example 1, the operations comprising: determining that the one or more predicates comprise an individual value; generating the set of fully-matched files in response to determining that a first column associated with the rows of the first group of files includes the individual value; and generating the set of partially-matched files in response to determining that a second column associated with the rows of the second group of files includes a range, the individual value falling within the range of the second column.

Example 3. The system of any one of Examples 1-2, the operations comprising: determining that the query comprises a select operation with a row limit value.

Example 4. The system of Example 3, the operations comprising: determining that a quantity of rows in the set of fully-matched files corresponds to the row limit value to determine that a result of performing the one or more database operations on the set of fully-matched files satisfies the row limit value.

Example 5. The system of Example 4, the query being received from a caller process, the operations comprising: skipping over scanning rows of the set of partially-matched files in response to determining that the result of performing the one or more database operations on the set of fully-matched files satisfies the row limit value; and returning the result to the caller process in response to determining that the result of performing the one or more database operations on the set of fully-matched files satisfies the row limit value and without scanning rows of the set of partially-matched files.

Example 6. The system of any one of Examples 3-5, the operations comprising: determining that a result of performing the one or more database operations on the set of fully-matched files fails to satisfy the row limit value; and in response to determining that the result of performing the one or more database operations on the set of fully-matched files fails to satisfy the row limit value, scanning the set of partially-matched files to identify a target group of files having rows that match each of the one or more predicates of the query.

Example 7. The system of Example 6, the operations comprising: performing, based on the query, the one or more database operations on the target group of files of the set of partially-matched files to return a result to a caller process.

Example 8. The system of any one of Examples 1-7, the operations comprising: determining that the query comprises an aggregation operation; and in response to determining that the query comprises the aggregation operation, obtaining a first aggregation value representing a count, sum, or average of rows of the set of fully-matched files without scanning the set of fully-matched files.

Example 9. The system of Example 8, the operations comprising: scanning the set of partially-matched files to identify a target group of files having rows that match each of the one or more predicates of the query; obtaining a second aggregation value representing a count, sum, or average of rows of the target group of files of the set of partially-matched files or minimum or maximum value of the rows of the target group of files; and returning a result to a caller process based on the first aggregation value and the second aggregation value.

Example 10. The system of any one of Examples 1-9, the operations comprising: determining that the query comprises a top/limit elements operation and/or order by operation; in response to determining that the query comprises the top/limit elements operation and/or order by operation, scanning the set of fully-matched files to identify a first target group of files having rows with values that satisfy the top elements operation; and generating a boundary based on the values of the rows of the first target group of files.

Example 11. The system of Example 10, the operations comprising: scanning the set of partially-matched files to identify a second target group of files having rows that match each of the one or more predicates of the query; and pruning the second target group of files by applying the boundary to the rows of the second target group of files.

Example 12. The system of any one of Examples 1-11, the operations comprising: determining that the query comprises an interchange operation; applying the interchange operation to the set of fully-matched files without scanning the set of fully-matched files; and scanning the set of partially-matched files to selectively apply the interchange operation to those files that have rows that satisfy the one or more predicates.

Example 13. The system of Example 12, wherein the interchange operation comprises a clone operation, the operations comprising: adding a pointer to the fully-matched files in a new table; and adding, to the new table, a new copy of files within the set of partially-matched files having the rows that satisfy the one or more predicates.

Example 14. The system of any one of Examples 12-13, wherein the interchange operation comprises at least one of an insert operation, an update operation, a merge operation, or a clone operation.

Example 15. A method comprising: receiving a query comprising one or more predicates; processing metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query; and performing, based on the query, one or more database operations on the set of fully-matched files prior to processing the set of partially-matched files.

Example 25. A computer-storage medium comprising instructions that, when executed by at least one processor of a machine, configure the machine to perform operations comprising: receiving a query comprising one or more predicates; processing metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query; and performing, based on the query, one or more database operations on the set of fully-matched files prior to processing the set of partially-matched files.

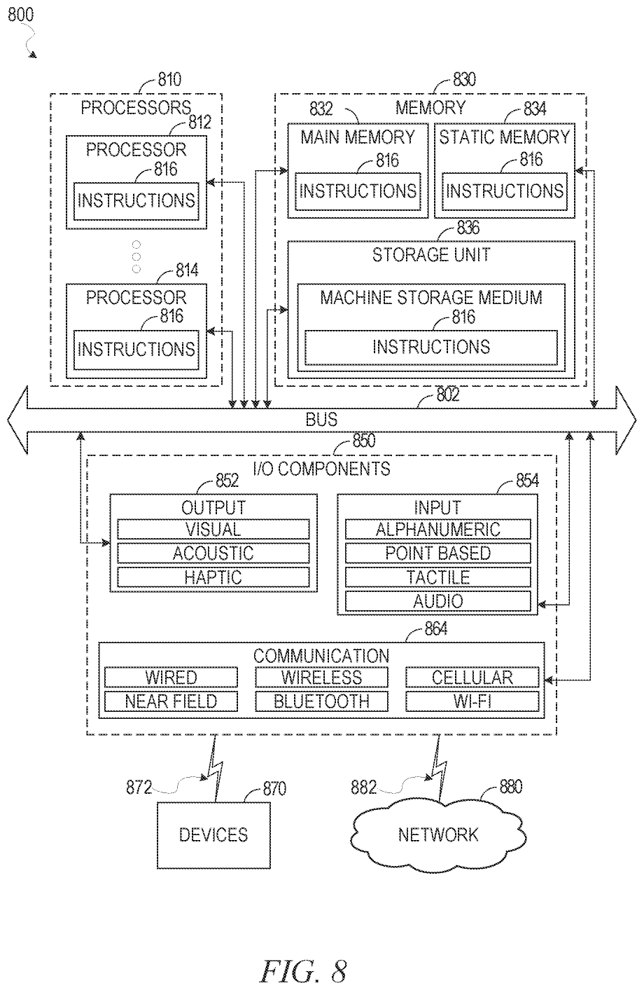

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute any one or more operations of the above processes (e.g., method 700). In this way, the instructions 816 transform a general, non-programmed machine into a particular machine 800 (e.g., the compute service manager 108 or one or more execution nodes of the execution platform 110) that is specially configured to carry out any one of the described and illustrated functions in the manner described herein.

In alternative examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and input/output (I/O) components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 870 may include any other computing device described herein as being in communication with the data platform 102.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the process or method 700 may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to execute operations comprising:
receiving a query comprising one or more predicates;
processing metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query; and
performing, based on the query, one or more database operations on the set of fully-matched files prior to processing the set of partially-matched files.

2. The system of claim 1, the operations comprising:
determining that the one or more predicates comprise an individual value;
generating the set of fully-matched files in response to determining that a first column associated with the rows of the first group of files includes the individual value; and
generating the set of partially-matched files in response to determining that a second column associated with the rows of the second group of files includes a range, the individual value falling within the range of the second column.

3. The system of claim 1, the operations comprising:
determining that the query comprises a select operation with a row limit value.

4. The system of claim 3, the operations comprising:
determining that a quantity of rows in the set of fully-matched files corresponds to the row limit value to determine that a result of performing the one or more database operations on the set of fully-matched files satisfies the row limit value.

5. The system of claim 4, the query being received from a caller process, the operations comprising:
skipping over scanning rows of the set of partially-matched files in response to determining that the result of performing the one or more database operations on the set of fully-matched files satisfies the row limit value; and
returning the result to the caller process in response to determining that the result of performing the one or more database operations on the set of fully-matched files satisfies the row limit value and without scanning rows of the set of partially-matched files.

6. The system of claim 3, the operations comprising:
determining that a result of performing the one or more database operations on the set of fully-matched files fails to satisfy the row limit value; and
in response to determining that the result of performing the one or more database operations on the set of fully-matched files fails to satisfy the row limit value, scanning the set of partially-matched files to identify a target group of files having rows that match each of the one or more predicates of the query.

7. The system of claim 6, the operations comprising:
performing, based on the query, the one or more database operations on the target group of files of the set of partially-matched files to return a result to a caller process.

8. The system of claim 1, the operations comprising:
determining that the query comprises an aggregation operation; and
in response to determining that the query comprises the aggregation operation, obtaining a first aggregation value representing a count, sum, or average of rows of the set of fully-matched files without scanning the set of fully-matched files.

9. The system of claim 8, the operations comprising:
scanning the set of partially-matched files to identify a target group of files having rows that match each of the one or more predicates of the query;
obtaining a second aggregation value representing a count, sum, or average of rows of the target group of files of the set of partially-matched files or a minimum or maximum value of the rows of the target group of files; and
returning a result to a caller process based on the first aggregation value and the second aggregation value.

10. The system of claim 1, the operations comprising:
determining that the query comprises a top/limit elements operation and order by operation;
in response to determining that the query comprises the top/limit elements operation and order by operation, scanning the set of fully-matched files to identify a first target group of files having rows with values that satisfy the top elements operation; and
generating a boundary based on the values of the rows of the first target group of files.

11. The system of claim 10, the operations comprising:
scanning the set of partially-matched files to identify a second target group of files having rows that match each of the one or more predicates of the query; and
pruning the second target group of files by applying the boundary to the rows of the second target group of files.

12. The system of claim 1, the operations comprising:
determining that the query comprises an interchange operation;
applying the interchange operation to the set of fully-matched files without scanning the set of fully-matched files; and
scanning the set of partially-matched files to selectively apply the interchange operation to those files that have rows that satisfy the one or more predicates.

13. The system of claim 12, wherein the interchange operation comprises a clone operation, the operations comprising:
adding a pointer to the fully-matched files in a new table; and
adding, to the new table, a new copy of files within the set of partially-matched files having the rows that satisfy the one or more predicates.

14. The system of claim 12, wherein the interchange operation comprises at least one of an insert operation, an update operation, a merge operation, or a clone operation.

15. A method comprising:
receiving, by one or more processors, a query comprising one or more predicates;
processing metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query; and
performing, based on the query, one or more database operations on the set of fully-matched files prior to processing the set of partially-matched files.

16. The method of claim 15, comprising:
determining that the one or more predicates comprise an individual value;
generating the set of fully-matched files in response to determining that a first column associated with the rows of the first group of files includes the individual value; and
generating the set of partially-matched files in response to determining that a second column associated with the rows of the second group of files includes a range, the individual value falling within the range of the second column.

17. The method of claim 15, comprising:
determining that the query comprises a select operation with a row limit value.

18. The method of claim 17, comprising:
determining that a quantity of rows in the set of fully-matched files corresponds to the row limit value to determine that a result of performing the one or more database operations on the set of fully-matched files satisfies the row limit value.

19. The method of claim 18, the query being received from a caller process, comprising:
skipping over scanning rows of the set of partially-matched files in response to determining that the result of performing the one or more database operations on the set of fully-matched files satisfies the row limit value; and
returning the result to the caller process in response to determining that the result of performing the one or more database operations on the set of fully-matched files satisfies the row limit value and without scanning rows of the set of partially-matched files.

20. The method of claim 17, comprising:
determining that a result of performing the one or more database operations on the set of fully-matched files fails to satisfy the row limit value; and
in response to determining that the result of performing the one or more database operations on the set of fully-matched files fails to satisfy the row limit value, scanning the set of partially-matched files to identify a target group of files having rows that match each of the one or more predicates of the query.

21. The method of claim 20, comprising:
performing, based on the query, the one or more database operations on the target group of files of the set of partially-matched files to return a result to a caller process.

22. The method of claim 15, comprising:
determining that the query comprises an aggregation operation; and
in response to determining that the query comprises the aggregation operation, obtaining a first aggregation value representing a count of rows of the set of fully-matched files without scanning the set of fully-matched files.

23. The method of claim 22, comprising:
scanning the set of partially-matched files to identify a target group of files having rows that match each of the one or more predicates of the query;
obtaining a second aggregation value representing a count of rows of the target group of files of the set of partially-matched files; and
returning a result to a caller process based on the first aggregation value and the second aggregation value.

24. The method of claim 15, comprising:
determining that the query comprises a top elements operation;
in response to determining that the query comprises the top elements operation, scanning the set of fully-matched files to identify a first target group of files having rows with values that satisfy the top elements operation; and
generating a boundary based on the values of the rows of the first target group of files.

25. A computer-storage medium comprising instructions that, when executed by at least one processor of a machine, configure the machine to perform operations comprising:
receiving a query comprising one or more predicates;
processing metadata associated with a database comprising a plurality of files to identify a set of fully-matched files and a set of partially-matched files, the set of fully-matched files comprising a first group of files in which all rows of each file match each of the one or more predicates of the query, the set of partially-matched files comprising a second group of files having rows that possibly match the one or more predicates of the query; and
performing, based on the query, one or more database operations on the set of fully-matched files prior to processing the set of partially-matched files.

26. The computer-storage medium of claim 25, the operations comprising:
determining that the one or more predicates comprise an individual value;
generating the set of fully-matched files in response to determining that a first column associated with the rows of the first group of files includes the individual value; and
generating the set of partially-matched files in response to determining that a second column associated with the rows of the second group of files includes a range, the individual value falling within the range of the second column.

27. The computer-storage medium of claim 26, the operations comprising:
determining that the query comprises a select operation with a row limit value.

28. The computer-storage medium of claim 27, the operations comprising:
determining that a quantity of rows in the set of fully-matched files corresponds to the row limit value to determine that a result of performing the one or more database operations on the set of fully-matched files satisfies the row limit value.

29. The computer-storage medium of claim 28, the query being received from a caller process, the operations comprising:
skipping over scanning rows of the set of partially-matched files in response to determining that the result of performing the one or more database operations on the set of fully-matched files satisfies the row limit value; and
returning the result to the caller process in response to determining that the result of performing the one or more database operations on the set of fully-matched files satisfies the row limit value and without scanning rows of the set of partially-matched files.

30. The computer-storage medium of claim 27, the operations comprising:
determining that a result of performing the one or more database operations on the set of fully-matched files fails to satisfy the row limit value; and
in response to determining that a result of performing the one or more database operations on the set of fully-matched files fails to satisfy the row limit value, scanning the set of partially-matched files to identify a target group of files having rows that match each of the one or more predicates of the query.
